(19) United States
(12) Patent Application Publication
(10) Pub. No.: US 2010/0090475 A1
(43) Pub. Date: Apr. 15, 2010

(54) Exercise Device Capable Of Generating Electricity

(76) Inventors: Wen-Bin TSAI, Sijhih City (TW); Chih-Hsien Chen, Sijhih City (TW)

Correspondence Address: HDLS Patent & Trademark Services, P.O. BOX 220746, CHANTILLY, VA, 20153-0746, US

(21) Appl. No.: 12/570,083

(22) Filed: Sep. 30, 2009

(30) Foreign Application Priority Data
Oct. 9, 2008 (TW) 097218158

(51) Int. Cl. F03G 5/06; G06F 19/00

(52) U.S. Cl. 290/1 A; 700/287

(57) ABSTRACT

An exercise device capable of generating electricity includes a generator unit, a power conversion unit, a controller unit, a power resistor unit, a human machine interface (HMI) unit and an energy conversion unit. The power conversion unit is electrically connected to the generator unit for receiving an AC power source outputted by the generator and converting it into a plurality of DC power sources. With stepping on the exercise device by external manpower to drive the generator unit to operate, the energy conversion unit is used to store the energy. Further, in the beginning of the operation of the exercise device, the energy conversion unit provides the HMI unit with necessary electricity. After the exercise device achieves a certain rotating speed, the power conversion unit is switched to provide the HMI unit with necessary electricity. With the above arrangement, the exercise device can be driven by an external force to generate electricity.

### BACKGROUND OF THE INVENTION

1. Field of the Invention

The present invention relates to an exercise device, and in particular to an exercise device driven by an external force to rotate and generate electricity.

2. Description of Prior Art

Recently, since the issue relating to the greenhouse effect has become more and more important and the petroleum is gradually exhausted, many people pay attention to the environmental protection. Thus, it is an important issue for everyone to carry out the environmental protection in daily life. In order to reduce the pollution of the environment and the use of petroleum, new-generation energy sources are developed, which are clean, inexhaustible in supply and always available for use without polluting the environment, such as water power, wind power, solar energy and even biomass energy. Thus, many nations in the world have introduced advanced technique, capitals and manpower to investigate the above-mentioned new energy sources conforming to the concept of environmental protection.

Fitness equipment, which can be used for exercise and generation of electricity by itself, has become more and more popular in the market. The conventional fitness equipment capable of generating electricity by itself is provided with external electric magnets, whereby the braking force for the fitness equipment can be generated. However, providing the external electric magnets will increase the cost. The eddy current loss caused by the magnetic filed of the electric magnets to the stator of the generator may cause the accumulation of heat in the generator. As a result, the operating temperature is so high as to lower the efficiency of the generator. Especially when operating at a low speed, the electricity generated by the generator is not sufficient to store and supply a human machine interface (HMI) of the fitness equipment. Therefore, in order to overcome the above problems, the present Inventor proposes an exercise device capable of generating electricity based on his delicate researches and expert experiments.

### SUMMARY OF THE INVENTION

The present invention is to provide an exercise device capable of generating electricity. Stepping on the exercise device with external manpower can drive a generator unit to charge and store energy in an energy conversion unit. In the beginning of the operation of the exercise device, the energy conversion unit supplies electricity necessary for a human machine interface (HMI) unit. After the operating speed of the exercise device achieves to a certain value, a power conversion unit is switched to supply electricity necessary for the HMI unit. In this way, the exercise device can be driven by an external force to generate electricity.

The present invention provides an exercise device capable of generating electricity, which includes a generator unit, a power conversion unit, a controller unit, a power resistor unit, a human machine interface (HMI) unit and an energy conversion unit. The generator unit is used to generate an AC power source. The power conversion unit is electrically connected to the generator unit for receiving the AC power source and converting it into a plurality of DC power sources. The controller unit is electrically connected to the power conversion unit for receiving a first operating power source outputted by the power conversion unit and outputting a power control signal to the power conversion unit. The energy conversion unit is electrically connected to the power conversion unit for receiving and storing a second operating power source outputted by the power conversion unit and outputting a charging output power source. The HMI unit is electrically connected to the power conversion unit and the energy conversion unit respectively for receiving a third operating power source outputted by the power conversion unit or the charging output power source outputted by the energy conversion unit, and for outputting an interface operating signal to the controller unit. The power resistor unit is electrically connected to the power conversion unit for receiving a fourth operating power source outputted by the power conversion unit, thereby consuming a portion of the electricity generated by the generator unit.

In order to better understand the technique, measure and effect of the present invention, please refer to the following description and the accompanying drawings of the present invention. However, the drawings are illustrative only but not used to limit the present invention.

### BRIEF DESCRIPTION OF THE DRAWINGS

FIG. 1 is a schematic view showing a preferred embodiment of the exercise device capable of generating electricity according to the present invention;

FIG. 2 is a perspective view showing the generator unit of the present invention; and

FIG. 3 is a block view showing the control of the exercise device of the present invention.

### DETAILED DESCRIPTION OF THE INVENTION

In the following, the technical contents of the present invention will be described with reference to the accompanying drawings.

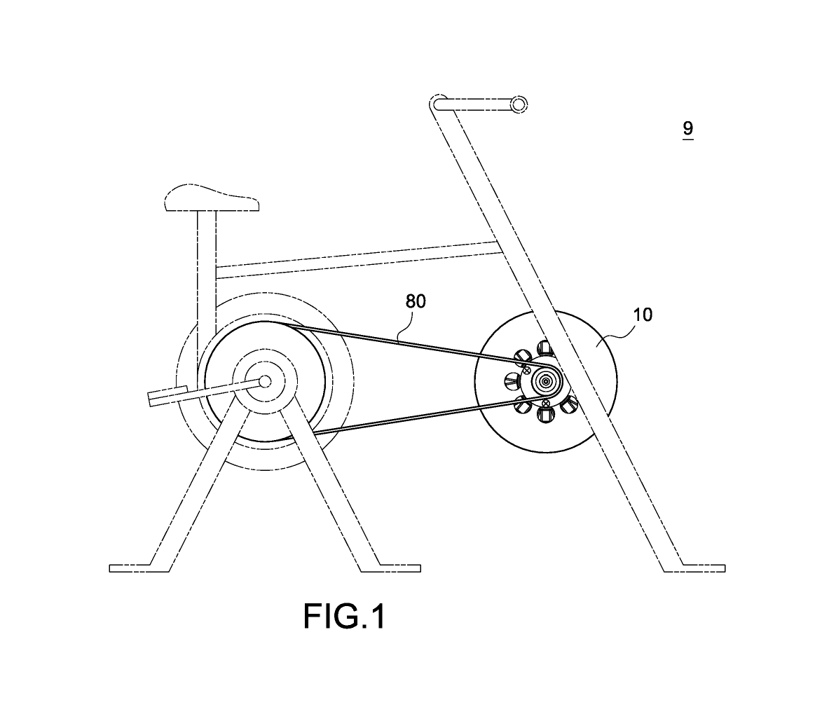

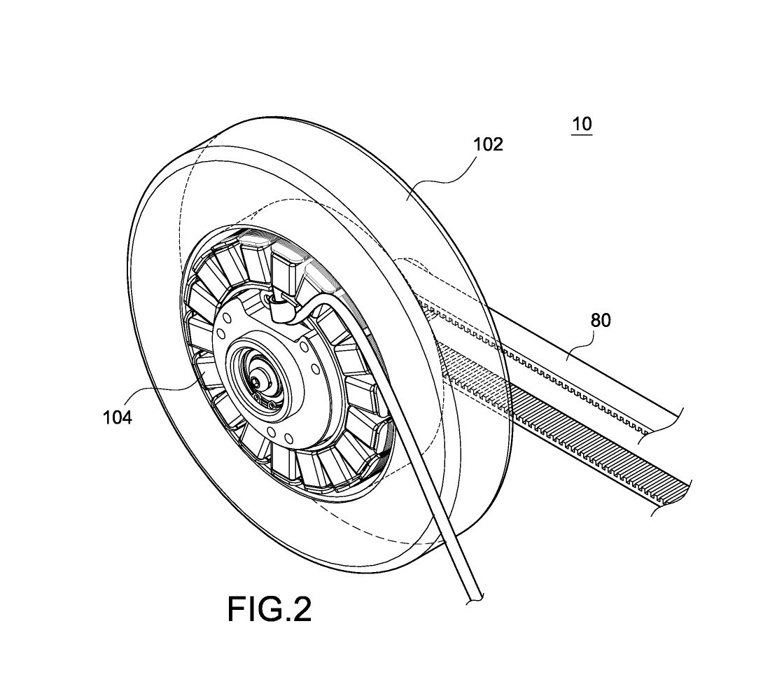

Please refer to FIGS. 1 and 2. FIG. 1 is a schematic view showing a preferred embodiment of the exercise device capable of generating electricity according to the present invention, and FIG. 2 is a perspective view showing the generator unit of the present invention. As shown in FIG. 1, the exercise device 9 is an exercise bike. The exercise device 9 comprises a generator unit 10 and a belt 80. When the exercise device 9 is used, a user can step on a rear wheel (not shown) of the exercise device 9, so that the belt 80 or a chain can drive the generator unit 10 to operate. As shown in FIG. 2, the generator 10 can be a brushless permanent magnetic synchronous generator with an external rotor, which comprises a rotor 101 and a stator 104. The rotor 102 is constituted of a plurality of permanent magnets for providing a plurality of magnetic poles. The rotor 102 can be driven to rotate by an external force, such as manpower. The stator 104 has a plurality of toothed slots for allowing a coil winding to be disposed therein. The coil winding generates an internal resistance to the operation of the generator unit 10. The stator 104 outputs an AC power source generated by the generator unit 10.

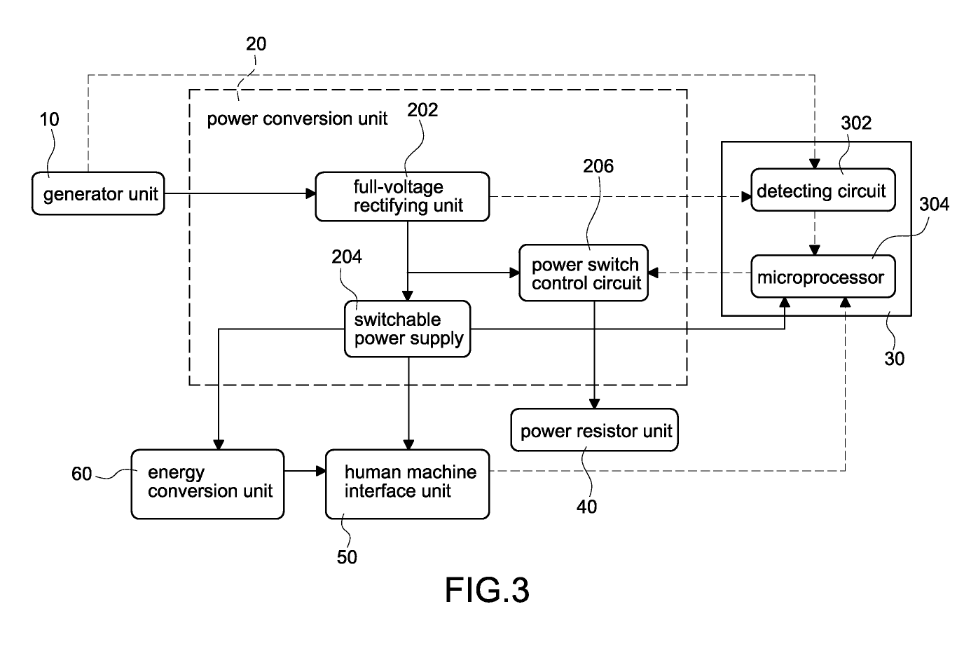

Please refer to FIG. 3, which is a block view showing the control of the exercise device of the present invention. The exercise device 9 comprises the generator unit 10, a power conversion unit 20, a controller unit 30, a power resistor unit 40, a human machine unit (HMI) unit 50, and an energy conversion unit 60.

The power conversion unit 20 is electrically connected to the generator unit 10 for receiving the AC power source and converting it into a plurality of DC power sources. The power conversion unit 20 comprises a full-voltage rectifying circuit 202, a switchable power supply 204 and a power switch control circuit 206. The full-voltage rectifying circuit 202 is electrically connected to the generator unit 10 for converting the AC power source generated by the generator unit 10 into a rectified output power source. The switchable power supply 204 is electrically connected to the full-voltage rectifying circuit 202 for switching the range of a rectified output voltage of the rectified output power source. The power switch control circuit 206 is electrically connected to the full-voltage rectifying circuit 202 for supplying a switch voltage and a switch current of a variable duty cycle.

The controller unit 30 is electrically connected to the power conversion unit 20 for receiving a first operating power source outputted by the power conversion unit 20 and outputting a power control signal to the power conversion unit 20. The controller unit 30 comprises a detecting circuit 302 and a microprocessor 304. The detecting circuit 302 is used for detecting a rectified output current and rectified output voltage outputted by the power conversion unit 20 and a rotating speed signal outputted by the generator unit 10, and for outputting a detecting output signal. The microprocessor 304 provides the power control signal to the power conversion unit 20 based on the detecting output signal and the interface operating signal.

The energy conversion unit 60 is electrically connected to the power conversion unit 20 for receiving and storing a second operating power source outputted by the power conversion unit 20, and for outputting a charging output power source. The second operating power source is generated by a charging circuit (not shown) that is electrically connected with the switchable power supply 204. The energy conversion unit 60 may be a charging battery or an ultra-capacitor. The energy conversion unit 60 can be externally connected with a DC/AC converter (not shown) available in the market for outputting an AC utility power and connecting in parallel to an external power system network (not shown).

The HMI unit 50 is electrically connected to the power conversion unit 20 and the energy conversion unit 60 respectively for receiving a third operating power source outputted by the power conversion unit 20 or the charging output power source outputted by the energy conversion unit 60, and for outputting an interface operating signal to the controller unit 30. The HMI unit 50 may be a liquid crystal display panel (not shown) or a light emitting diode lamp assembly (not shown) for providing a user with data displayed in operating the exercise device (such as speed time, distance, total distance, calorie, rotating speed or etc.); an audio/video player (not shown) for playing audio/video signals to add interest and variability in use; or a fan (not shown) for keeping good ventilation when exercising indoors. It should be noted that, when the user just begins to use the exercise device, the energy conversion unit 60 provides the HMI unit 50 with necessary electricity. After the user uses the exercise device for a period of time, the switchable power supply is switched to provide the HMI unit 50 with necessary electricity.

The power resistor unit 40 is electrically connected to the power conversion unit 20 for receiving a fourth operating power source outputted by the power conversion unit 20, thereby consuming a portion of electricity generated by the generator unit 10.

According to the above, the present invention has advantageous features as follows.

(1) The HMI unit can be supplied with electricity by different ways. That is, in the beginning of the operation of the exercise device, the energy conversion unit provides the HMI unit with necessary electricity. After the exercise device rotates to a certain speed, the switchable power supply is switched to provide the HMI unit 50 with necessary electricity.

(2) The power resistor unit is used to receiving an operating power source outputted by the power conversion unit, thereby consuming a portion of electricity generated by the generator unit.

(3) The power resistor unit is provided outside the generator unit, so that the heat generated by the generator unit can be prevented from accumulating in the coil winding of the stator. As a result, the redundant wiring of the coil winding can be avoided, thereby reducing the volume of the stator.

(4) The exercise device can be driven by an external force to generate electricity by itself, thereby providing the electricity necessary for the operation of the exercise device itself. Thus, not only the exercise device can be operated at a low rotating speed, but also the rotating torque and the rotating power can be kept constant.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An exercise device capable of generating electricity, including:
a generator unit used to generate an AC power source;
a power conversion unit electrically connected to the generator unit for receiving the AC power source and converting the AC power source into a plurality of DC power sources;
a controller unit electrically connected to the power conversion unit for receiving a first operating power source outputted by the power conversion unit and outputting a power control signal to the power conversion unit;
an energy conversion unit electrically connected to the power conversion unit for receiving and storing a second operating power source outputted by the power conversion unit and outputting a charging output power source;
a human machine interface (HMI) unit electrically connected to the power conversion unit and the energy conversion unit respectively for receiving a third operating power source outputted by the power conversion unit or the charging output power source outputted by the energy conversion unit and outputting an interface operating signal to the controller unit; and
a power resistor unit electrically connected to the power conversion unit for receiving a fourth operating power source outputted by the power conversion unit, thereby consuming a portion of the electricity generated by the generator unit.

2. The exercise device capable of generating electricity according to claim 1, wherein the generator unit comprising:
a rotor constituted of a plurality of permanent magnets for providing a plurality of magnetic poles, the rotor being driven by an external force to rotate; and
a stator having a plurality of toothed slots for allowing a coil winding to be disposed therein, the coil winding generating an internal resistance to the operation of the generator unit, the stator outputting the AC power source generated by the generator unit.

3. The exercise device capable of generating electricity according to claim 1, wherein the power conversion unit comprises:
a full-voltage rectifying circuit electrically connected to the generator unit for converting the AC power source generated by the generator unit into a rectified output power source;
a switchable power supply electrically connected to the full-voltage rectifying circuit for switching a range of a rectified output voltage of the rectified output power source; and
a power switch control circuit electrically connected to the full-voltage rectifying circuit for providing a switch voltage and a switch current of a variable duty cycle.

4. The exercise device capable of generating electricity according to claim 1, wherein the controller unit comprises:
a detecting circuit for detecting a rectified output current and a rectified output voltage outputted by the power conversion unit and a rotating speed signal outputted by the generator unit, and for outputting a detecting output signal; and
a microprocessor for providing the power control signal to the power conversion unit based on the detecting output signal and the interface operating signal.

5. The exercise device capable of generating electricity according to claim 1, wherein the generator unit is a brushless permanent magnetic synchronous generator with an external rotor.

6. The exercise device capable of generating electricity according to claim 1, wherein the external force is manpower.

7. The exercise device capable of generating electricity according to claim 1, wherein the HMI unit is a liquid crystal display panel, a light emitting diode lamp assembly, an audio/video player or a fan.

8. The exercise device capable of generating electricity according to claim 1, wherein the energy conversion unit is a charging battery or an ultra-capacitor.

9. The exercise device capable of generating electricity according to claim 1, wherein the exercise device is an exercise bike.

10. The exercise device capable of generating electricity according to claim 9, wherein the exercise bike comprises a belt, the belt drives the rotor by means of an external force.

11. The exercise device capable of generating electricity according to claim 1, wherein the energy conversion unit is a DC/AC converter externally connected in parallel to a utility power for outputting an AC utility power.
